(19) United States
(12) Patent Application Publication
(10) Pub. No.: US 2018/0084329 A1
(43) Pub. Date: Mar. 22, 2018

(54) ACCESSORY FOR ATTACHING WIRELESS EARBUDS AND MODIFIED EARBUDS FOR USE THEREWITH

(71) Applicant: Genal Strap Inc., Brooklyn, NY (US)

(72) Inventors: ROBERT SHADOWENS, Grand Rapids, MI (US); JOANNE VAILLANCOURT, Howell, NJ (US)

(21) Appl. No.: 15/421,997

(22) Filed: Feb. 1, 2017

Related U.S. Application Data
(60) Provisional application No. 62/428,108, filed on Nov. 30, 2016.
(60) Provisional application No. 62/416,221, filed on Nov. 2, 2016.
(60) Provisional application No. 62/398,126, filed on Sep. 22, 2016.

(51) Int. Cl. H04R 1/10

(52) U.S. Cl. CPC H04R 1/1066; H04R 2420/07; H04R 1/1016; H04R 1/105

(57) ABSTRACT

The accessory attaches first and second wireless earbuds to each other. The accessory includes an elongated flexible member in the form of a chain, chord, braid or the like which extends between the earbuds. The elongated member has, at each end thereof, a part connected to the end of the member which is adapted to engage a different one of the earbuds. The engaging part may take the form of a rubber sleeve which frictionally engages the earbud stem for use with a conventional earbud or a threaded section which engages the threaded section of a modified earbud. In one embodiment, the modified earbud has a protruding loop member and the engaging part takes the form of a clasp. Ornamental elements of various types can be attached to the member.

### CROSS-REFERENCE TO RELATED APPLICATIONS

Priority is claimed on the following:
(a) Provisional Patent Application Ser. No. 62/398,126 filed Sep. 22, 2016;
(b) Provisional Patent Application Ser. No. 62/416,221 filed Nov. 2, 2016; and
(c) Provisional Patent Application Ser. No. 62/428,108 filed Nov. 30, 2016.

Each of the above is incorporated herein by reference in its entirety.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

### 1. Field of the Invention

The present invention relates to wireless earbuds and more particularly to an accessory for use with a pair of wireless earbuds which connects the earbuds together allowing the user to wear the earbuds without one or both of the earbuds falling out of the ears of the user and becoming lost, and to modified earbuds for use therewith.

### 2. Description of Prior Art Including Information Disclosed Under 37 CFR 1.97 and 1.98

Bluetooth individual stereo in ear headphones, commonly called “earbuds” are sold by a variety of manufacturers and have become very popular because they are able to produce sound with improved quality as compared to conventional headphones and with minimal outside interference. As the term “earbuds” is used herein, it is intended to be broadly construed to include all sound producing devices designed to be received in the ear of the user which are provided in pairs to wirelessly work in unison but are not physically connected together by a power cord.

However, a problem inherent with wireless earbuds is that they are very small and can easily fall out of the ear of the user and become lost, especially if the earbud does not fit snuggly in the ear of the user.

Accordingly, there is a need for an attachment in the form of an accessory which will prevent or at least greatly reduce the possibility of losing an earbud. Further, it is preferable that the accessory be detachable from the earbud so that the accessory can be used with different pairs of earbuds.

Moreover, there is a need for modified earbuds designed for use with such accessory.

It is also desirable that the accessory have an esthetically pleasing appearance. That may include the capability of carrying one or more ornamental elements such as a charm.

### BRIEF SUMMARY OF THE INVENTION

It is a prime object of the present invention to provide an accessory for attaching wireless earbuds.

It is another object of the present invention to provide an accessory for attaching wireless earbuds which consists of an elongated, flexible member adapted to connect the earbuds to each other.

It is another object of the present invention to provide an accessory for attaching wireless earbuds which includes parts at either end of the elongated member for engaging the earbuds.

It is another object of the present invention to provide an accessory for attaching wireless earbuds and modified earbuds for use therewith.

It is another object of the present invention to provide an accessory for attaching wireless earbuds in which the elongated member may take the form of a chain, cord, braid, rope, strap, band or the like.

It is another object of the present invention to provide an accessory for attaching wireless earbuds which can be easily engage and disengage the earbuds.

It is another object of the present invention to provide an accessory for attaching wireless earbuds which prevents or greatly reduces the likelihood that the earbuds will get lost.

It is another object of the present invention to provide an accessory for attaching wireless earbuds which has an esthetically pleasing appearance.

It is another object of the present invention to provide an accessory for attaching wireless earbuds which can carry one or more ornamental elements.

It is another object of the present invention to provide an accessory for attaching wireless earbuds which has a simple structure that can be fabricated inexpensively.

Those objects in general are achieved by the present invention which relates to an accessory for attaching first and second wireless earbuds to each other. The accessory includes an elongated flexible member having first and second ends. The member is adapted to extend between the earbuds. The member has, at each end thereof, a part including means for engaging the associated earbud. Also provided are means for connecting each engaging part to a different end of the member.

In one preferred embodiment, designed for use with conventional earbuds having a generally cylindrical stem, the engaging part includes a hollow tubular sleeve adapted to receive and frictionally engage the stem of the associated earbud. Preferably, the sleeve is formed of resilient material, such as rubber.

The sleeve has a rim or edge. Preferably, the sleeve edge is situated in a plane which is inclined relative to the centerline of the sleeve.

In another preferred embodiment, designed for use with earbuds modified to include a threaded section, the engaging part includes a threaded section adapted to engage the threaded section of the earbud. One of the threaded section of the earbud and the threaded section of the engaging part is internally threaded. The other of the threaded section of the earbud and the threaded section of the engaging part is externally threaded.

The modified earbud may include a removable cap configured to mount over the threaded section of the earbud. Alternatively, the cap may be externally threaded and adapted to be received within an internally threaded section of the earbud.

In another preferred embodiment, the earbud is modified to include a protruding loop member. In that embodiment, the engaging part includes a clasp adapted to detachably engage the loop member. The clasp may take the form of a “lobster-claw” type clasp.

The elongated member may take the form of a chain, a cord, a braid, a rope, a strap or a decorative band.

The member may carry an ornamental element. The ornamental element may take the form of a charm, bead or stone.

In accordance with another aspect of the present invention, first and second wireless earbuds are provided in combination with an accessory for attaching the first and second wireless earbuds to each other. The accessory includes an elongated flexible member extending between the earbuds. At each end of the member, an engaging part is situated. The part is adapted to engage a different one of the earbuds.

When the accessory is designed for use with earbuds modified to include threaded sections, the engaging parts are adapted to co-operate with threaded sections of the earbuds.

One of the threaded section of the earbuds and the threaded section of the engaging part is internally threaded. The other of the threaded section of the earbuds and the threaded sections of the engaging part is externally threaded.

When the accessory is modified to include a protruding loop member, the engaging parts take the form of a clasp.

An ornamental element may be attached to the member.

In accordance with another aspect of the present invention, an earbud is provided with a stem having a threaded section.

A cap is provided with a threaded section adapted to co-operate with the threaded section of the earbud.

In accordance with another aspect of the present invention, an earbud is provided with a housing having a protruding loop member.

### BRIEF DESCRIPTION OF THE SEVERAL VIEWS OF DRAWINGS

To these and to such other objects that may hereinafter appears, the present invention relates to an accessory for attaching wireless earbuds and to modified earbuds for use therewith as described in detail in the following specification and recited in the annexed claims, taken together with the accompanying drawings, in which like numerals refer to like parts and in which:

FIG. 1 is an elevation view of a preferred embodiment of the accessory of the present invention for use with standard earbuds in which the engaging parts take the form of rubber sleeves connected together with a braid from which a charm extends;

FIG. 2 is an elevation view of the accessory similar to that of FIG. 1 in which the elongated member takes the form of a cord which carries a set of beads;

FIG. 3 is an elevation view of an earbud modified to have a screw cap mounted thereon;

FIG. 4 is an exploded view of the modified earbud and cap of FIG. 3;

FIG. 5 is an elevation view of a preferred embodiment of the accessory of the present invention designed for use with the modified earbud of FIGS. 3 and 4 which includes of internally threaded engaging parts connected together with a rope from which a stone extends;

FIG. 6 is an exploded view a modified earbud with an internally threaded stem and a cap with an externally threaded section for use thereon;

FIG. 7 is an elevation view of a preferred embodiment of the accessory of the present invention designed for use with the modified earbud of FIG. 6 which consists of an elongated member with externally threaded engaging parts at each end connected together with a cable; and

FIG. 8 is an elevation view of a preferred embodiment of the accessory of the present invention designed for use with earbuds modified to include protruding loop members (only one of which is shown) in which the engaging parts take the form of “lobster claw” type clasps (only one of which is shown) connected to each other with a chain.

### DETAILED DESCRIPTION OF THE INVENTION

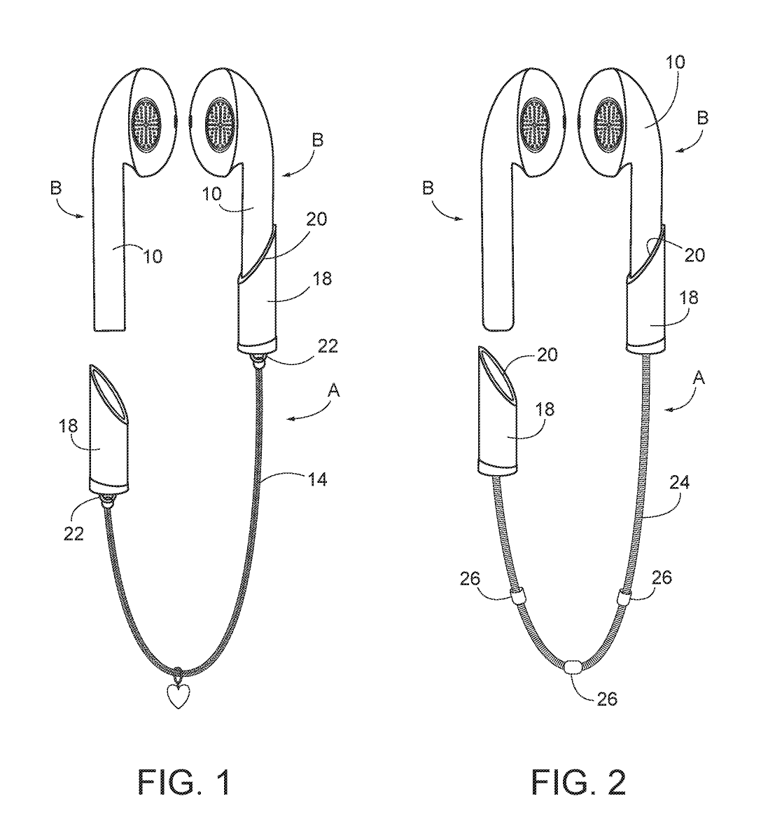

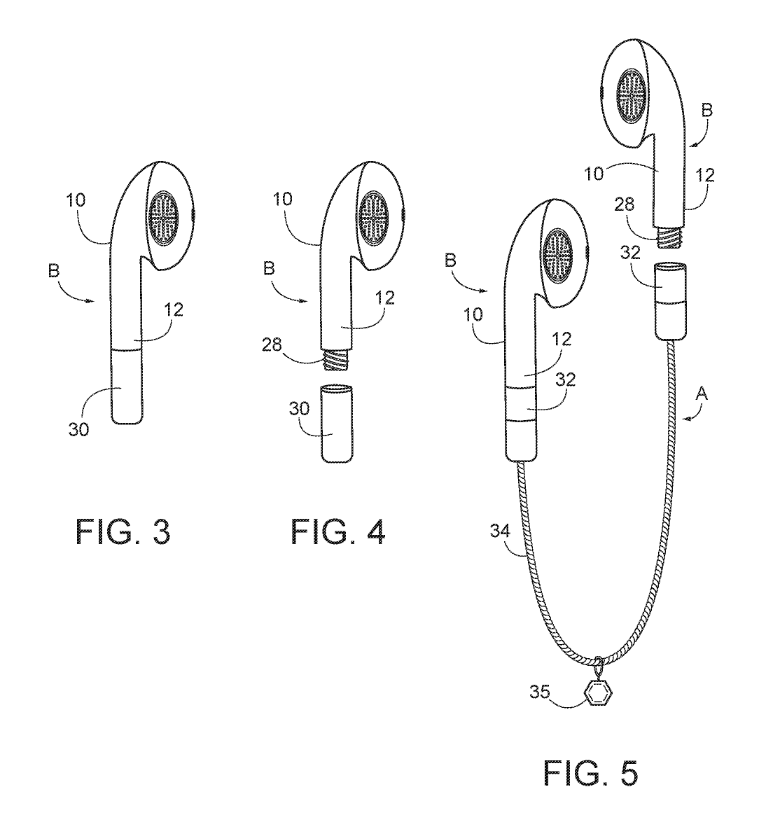

As seen in the drawings, the invention is an accessory, generally designated A, for attaching first and second wireless earbuds together, each of which is generally designated B. Each of the earbuds B includes a housing 10, formed of plastic or metal. Housing 10 may include a substantially cylindrical stem 12, as seen in FIGS. 1 through 7.

Attachment A includes an elongated flexible member, generally designated 14. Member 14 is adapted to extend between and connect earbuds B. The ends of member 14 are attached to the housing 10 of one of the earbuds B and the housing 10 of the other of the earbuds B, respectively.

Member 14 includes a part 16 connected to each end thereof. Each part 16 is adapted to engage the housing 10 of a different one of the earbuds B.

Engaging part 16 is configured in accordance with the structure of the particular earbud with which the accessory is intended to be used.

In one preferred embodiment, as illustrated in FIG. 1, the accessory is designed for use with conventional earbuds having downwardly extending generally cylindrical stems 12. In this embodiment, each of the engaging parts 16 takes the form of a hollow sleeve 18. Sleeve 18 may be made of rubber or other resilient material. Each sleeve is adapted to receive and frictionally engage the stem 12 of a different one of the earbuds B. Each sleeve 18 may have a rim or edge 20 which is situated in a plane that is inclined relative to the central axis of the sleeve.

Member 14 may take the form of a braid, as seen in FIG. 1. Each of the sleeves 18 is provided with a loop member 22 for attaching the end of braid 14 to the associated sleeve 18.

The preferred embodiment of the invention illustrated in FIG. 2 is similar to that of FIG. 1 except that instead of braid 14, a cord 24 extends between and connects the earbuds. In this embodiment, decorative beads 26 are carried by cord 24.

In another preferred embodiment, as seen in FIGS. 4 and 5, the stem 12 of each earbud B is modified to have an externally threaded section 28. Section 28 is adapted to receive an internally threaded removable cap 30, which may be provided with the modified earbud. With cap 30 removed, internally threaded engaging parts 32 of the accessory can be attached the earbuds. Engaging parts 32 can be connected by a rope 34. The elongated member 34 of FIG. 5 carries a stone 35, which may be a cut semi-precious stone.

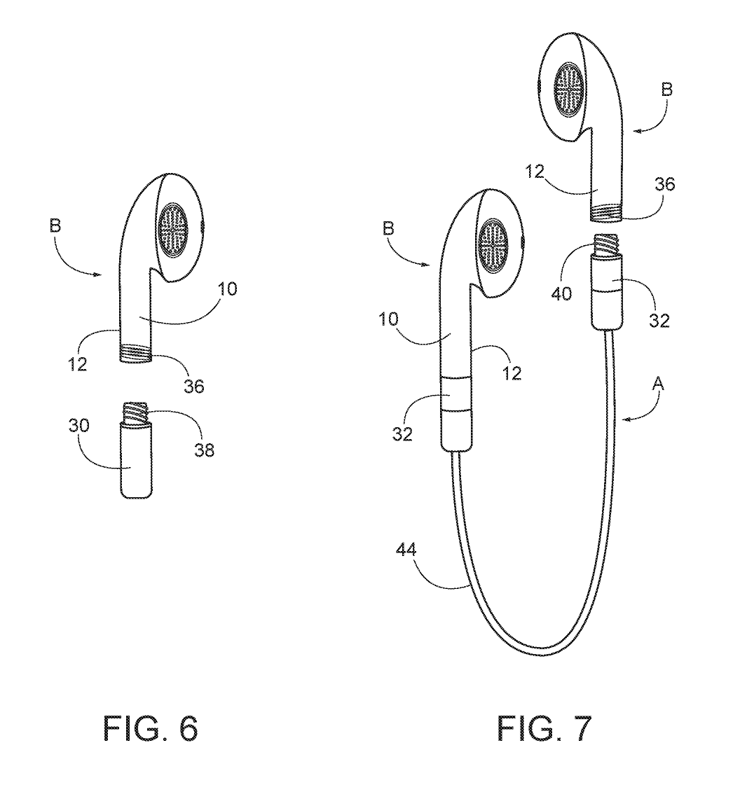

The preferred embodiment shown in FIGS. 6 and 7 is similar to the embodiment of FIGS. 4 and 5 except that the stem 12 of each earbud B is modified to have an internally threaded section 36 and the engaging parts 32 are provided with externally threaded sections 40 adapted to be received in sections 36. Engaging parts 32 are attached to the ends of cable 44.

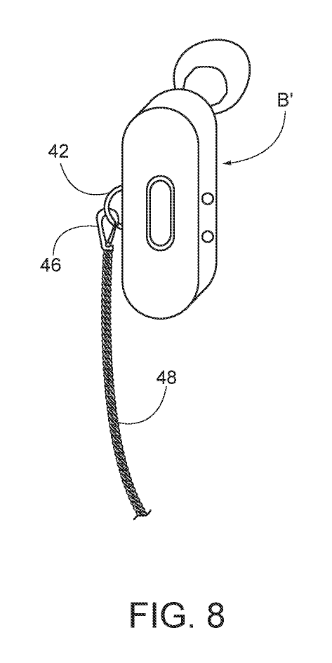

The preferred embodiment illustrated in FIG. 8 the accessory is designed for use with earbuds B′ which are modified to include a loop member 42 protruding from the surface of the earbud housing. Each of the engaging parts takes the form of a clasp 46 adapted to engage a loop member 42 of a different one of the earbuds B′. Clasp 46 is illustrated as being a “lobster-claw” type clasp. Engaging parts 46 are connected to each other by a chain 48.

In any of the embodiments, the elongated flexible member may take the form of a chain, chord, braid, rope, strap or decorative band.

Further, in any of the embodiments, the member may carry one or more ornamental elements, including charms, beads or stones.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims:

We claim:

1. An accessory for attaching first and second wireless earbuds to each other, said accessory comprising an elongated flexible member extending between the earbuds, and at each end of said member, a part connected to said end adapted to engage a different one of the earbuds.

2. The attachment of claim 1 wherein each earbud includes a stem and wherein each of said engaging parts comprises a sleeve adapted to receive and frictionally engage the stem of the engaged earbud.

3. The attachment of claim 2 wherein said sleeve is formed of resilient material.

4. The attachment of claim 2 wherein said sleeve is made of rubber.

5. The attachment of claim 2 wherein said sleeve has a centerline and a rim, and wherein said rim is situated in a plane inclined relative to said centerline of said sleeve.

6. The attachment of claim 1 designed for use with earbuds modified to have a threaded section, wherein each of said engaging parts comprises a threaded section adapted to engage the threaded section of an associated earbud.

7. The attachment of claim 6 wherein one of the threaded section of the earbud and said threaded section of said engaging part is internally threaded and the other of the threaded section of the earbud and said threaded section of said engaging part is externally threaded.

8. The attachment of claim 6 for use with a removable cap adopted to be received on the threaded section of the earbud.

9. The attachment of claim 1 wherein the earbud is modified to have a stem with a threaded section, said engaging part has a threaded section, and wherein one of the threaded section of the stem and said threaded section of said engaging part is internally threaded and the other of the threaded section of the stem and said threaded section of said engaging part is externally threaded.

10. The attachment of claim 1 wherein the earbud is modified to have a protruding loop member and said engaging part comprises a clasp adapted to engage the loop member.

11. The attachment of claim 10 wherein said clasp is adapted to detachably engage the loop member.

12. The attachment of claim 1 wherein said member comprises a chain.

13. The attachment of claim 1 wherein said member comprises a cord.

14. The attachment of claim 1 wherein said member comprises a braid.

15. The attachment of claim 1 wherein said member comprises a rope.

16. The attachment of claim 1 wherein said member comprises a strap.

17. The attachment of claim 1 wherein said member comprises a band.

18. The attachment of claim 1 wherein said accessory comprises an ornamental element.

19. In combination, first and second wireless earbuds and an accessory for attaching said first and second wireless earbuds to each other, said accessory comprising an elongated flexible member extending between said earbuds, and at each end of said member, a part connected to said accessory end adapted to engage a different one of said earbuds.

20. The combination of claim 19 further comprising an ornamental element attached to said member.

21. The combination of claim 19 wherein one of the threaded section of the earbuds and the threaded section of the engaging part is internally threaded and the other of the threaded section of the earbuds and the threaded sections of the engaging part is externally threaded.

22. The combination of claim 19 wherein the earbud is modified to include a protruding loop member, and wherein the engaging parts take the form of a clasp.

23. An earbud comprising a stem having a threaded section.

24. In combination with the earbud of claim 23, a cap with a threaded section adapted to co-operate with the threaded section of said earbud.

25. An earbud comprising a housing having a protruding loop member.
